(19) United States
(12) Patent Application Publication
(10) Pub. No.: US 2010/0247977 A1
(43) Pub. Date: Sep. 30, 2010

(54) SUBASTRATE FOR A MAGNETIC DISK AND METHOD OF MANUFACTURING THE SAME

(75) Inventors: Hiroshi Tsuchiya, Tokyo (JP); Junpei Fukada, Tokyo (JP); Takanori Mizuno, Tokyo (JP)

Correspondence Address: AMSTER, ROTHSTEIN & EBENSTEIN LLP, 90 PARK AVENUE, NEW YORK, NY, 10016, US

(73) Assignee: HOYA CORPORATION, Tokyo (JP)

(21) Appl. No.: 12/749,044

(22) Filed: Mar. 29, 2010

(30) Foreign Application Priority Data
Mar. 30, 2009 (JP) 2009-081699
Dec. 25, 2009 (JP) 2009-293759

(51) Int. Cl. G11B 5/73; G11B 5/84; B24B 1/00

(52) U.S. Cl. 428/846.9; 428/848.6; 427/129; 451/41

(57) ABSTRACT

In a magnetic disk substrate having first and second chamfered faces respectively connecting between first and second main surfaces opposite to each other and an edge face located between the first and second main surfaces, the ranges of the first and second chamfered faces are specified. Specifically, the distance a from a first boundary portion being a boundary between the first main surface and the first chamfered face to a point of intersection between the first main surface and an extended line of the edge face and the distance b from a second boundary portion being a boundary between the second main surface and the second chamfered face to a point of intersection between the second main surface and an extended line of the edge face are set to satisfy a/b≧1.6.

### CROSS REFERENCE TO RELATED APPLICATIONS

This application is claims the benefit of priority from Japanese Patent Application No. 2009-081699, filed on Mar. 30, 2009, and Japanese Patent Application No. 2009-293759, filed on Dec. 25, 2009, the disclosures of which are incorporated herein in their entirety by reference.

### TECHNICAL FIELD

This invention relates to a substrate for a magnetic disk for use in a magnetic disk device such as a hard disk drive (HDD) and to a method of manufacturing the same. Hereinafter, a substrate for a magnetic disk will also be referred to as a magnetic disk substrate.

### BACKGROUND

Currently, a magnetic disk having a magnetic layer on both main surfaces of a disk-shaped substrate is widely used in a hard disk drive. With the increase in capacity of the hard disk drive, a recording medium has shifted to the perpendicular magnetic recording type. Following this, low roughness, low waviness, low defect, flatness in end portion shape, and so on are cited as the qualities required for a substrate for a magnetic disk, i.e. a magnetic disk substrate. Basically, these quality items can be dealt with by adjustments in a main surface polishing process and a subsequent cleaning process. In particular, with respect to the low roughness and low waviness, the ratio occupied by a final polishing process is high. For example, in the final polishing process, the low roughness and low waviness can be achieved by reducing the size of polishing abrasive particles and hardening and flattening polishing pads.

In the main surface polishing process, polishing is carried out by using, for example, a double-side polishing machine employing a planetary gear mechanism, which is shown in FIG. 3 (Patent Document 1: JP-A-2007-90452). FIG. 3 is a diagram showing a schematic structure of the polishing machine for use in a magnetic disk substrate manufacturing method. As shown in FIG. 3, the polishing machine employing the planetary gear mechanism has a pair of upper and lower polishing surface plates 2 and 1. These polishing surface plates 1 and 2 are each formed in a flat plate shape. On a surface of each polishing surface plate, a plurality of grooves 3 are formed in a lattice shape for supplying a polishing agent. Further, a soft-polisher (suede) polishing pad is attached to the surface of each polishing surface plate.

In the polishing machine of FIG. 3, a disk-shaped carrier 5 holding disk-shaped substrates 4 is placed between the polishing surface plates 1 and 2, then the carrier 5 is pressed between the polishing surface plates 1 and 2, and then the upper polishing surface plate 2 and the lower polishing surface plate 1 are rotated in opposite directions to each other, thereby polishing both main surfaces of the substrates 4 while supplying the polishing agent. In the planetary gear mechanism, the carrier 5 is placed between a sun gear 6 provided at a central portion of the lower polishing surface plate 1 and an internal gear 7 provided at the outer periphery of the lower polishing surface plate 1. In this event, a tooth portion 8 provided on the circumference of the carrier 5 meshes with the sun gear 6 and the internal gear 7. Therefore, by rotating the upper polishing surface plate 2 and the lower polishing surface plate 1 in opposite directions to each other, the carrier 5 revolves around the sun gear 6, i.e. makes an orbital motion, while rotating on its axis. The substrates 4 are held in holes 5a of the carrier 5, respectively.

### SUMMARY OF THE INVENTION

On the other hand, however, as the smoothness of the substrate main surfaces increases by a combination of the secondary polishing materials (polishing pads, polishing abrasive particles, etc.), there arises a problem that, as shown at (a) in FIG. 4, the substrates 4, after the double-side polishing, adhere randomly to a polishing pad 9a on the upper polishing surface plate side and a polishing pad 9b on the lower polishing surface plate side. This reduces the workability and damages the substrates 4 in a substrate unloading (substrate removal) operation after the double-side polishing.

In order to solve such a problem, it is considered, as shown in FIG. 5, to provide grooves 9c on the polishing pad 9a to form a gap between the substrates 4 and the polishing pad 9a, thereby making it easy to strip the substrates 4 from the polishing pad 9a with the use of the fact that air enters this gap. However, by providing the grooves 9c on the polishing pad 9a in this manner, a level difference is formed on the polishing pad 9a and it may happen that the waviness (microwaviness) of the substrates 4 is degraded after the polishing and that the polishing pad 9a is stripped from the polishing surface plate due to the substrates 4.

This invention has been made in view of the above and has an exemplary object to provide a magnetic disk substrate capable of preventing it from adhering randomly to an upper or lower polishing surface plate after polishing without degrading the substrate quality and further to provide a method of manufacturing such a magnetic disk substrate.

According to an exemplary aspect of the present invention, there is provide a magnetic disk substrate which comprises a first and a second main surface opposite to each other, an edge face located between the first and second main surfaces, a first chamfered face connecting between the first main surface and the edge face, and a second chamfered face connecting between the second main surface and the edge face, wherein a distance a from a first boundary portion being a boundary between the first main surface and the first chamfered face to a point of intersection between the first main surface and an extended line of the edge face and a distance b from a second boundary portion being a boundary between the second main surface and the second chamfered face to a point of intersection between the second main surface and an extended line of the edge face are set to satisfy a/b≧1.6.

According to another exemplary aspect of the present invention, there is provided a method of manufacturing the above-mentioned magnetic disk substrate, the method comprising the steps of preparing a polishing machine comprising a pair of surface plates and a carrier which is placed between the surface plates and adapted to make an orbital motion while rotating on its axis, of making the carrier hold a plurality of disk-shaped substrates in parallel to each other, each of the disk-shaped substrates having a first and a second main surface which are faced to the surface plates, respectively, and of polishing the first and the second main surfaces with movement of the carrier to process the disk-shaped substrates into the magnetic disk substrate.

According to still another exemplary aspect of the present invention, there is provided a method of manufacturing a magnetic disk, comprising the steps of preparing the above-mentioned magnetic disk substrate and of forming at least a magnetic recording layer over at least one of the first and second main surfaces of the magnetic disk substrate.

According to yet another exemplary aspect of the present invention, there is provided magnetic disk manufactured by the above-mentioned magnetic disk manufacturing method.

### BRIEF DESCRIPTION OF THE DRAWINGS

FIG. 1 is a diagram showing part of a magnetic disk substrate according to an embodiment of this invention;

FIG. 2 is a diagram for explaining a method of manufacturing magnetic disk substrates according to the embodiment of this invention;

FIG. 3 is a diagram showing a polishing machine for use in a magnetic disk substrate manufacturing method;

FIG. 4 is a diagram for explaining a method of manufacturing conventional magnetic disk substrates; and

FIG. 5 is a diagram for explaining a method of manufacturing the conventional magnetic disk substrates.

### DETAILED DESCRIPTION OF EXEMPLARY EMBODIMENTS

Hereinbelow, an exemplary embodiment of this invention will be described in detail with reference to the drawings.

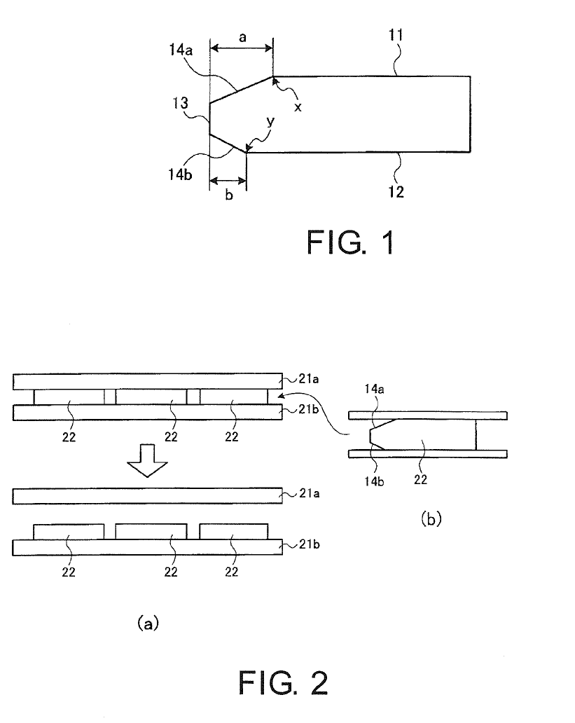

FIG. 1 is a diagram showing part of a magnetic disk substrate according to an example embodiment of this invention.

The magnetic disk substrate shown in FIG. 1 has a pair of first and second main surfaces (hereinafter also referred to as “both main surfaces”) 11 and 12 opposite to each other, an edge face 13 located between the first and second main surfaces 11 and 12, and first and second chamfered faces 14a and 14b connecting between the first and second main surfaces 11 and 12 and the edge face 13, respectively. The first chamfered face 14a is a chamfered face between the first main surface (upper surface) 11 and the edge face 13 and the second chamfered face 14b is a chamfered face between the second main surface (lower surface) 12 and the edge face 13. Herein, the distance from an extended line of the edge face 13 to an end x of the first chamfered face 14a with respect to the first main surface 11 is given by a and the distance from an extended line of the edge face 13 to an end y of the second chamfered face 14b with respect to the second main surface 12 is given by b. These distances a and b differ from each other, i.e. the chamfered lengths of the first and second main surfaces 11 and 12 differ from each other. Further, the distance a and the distance b of the magnetic disk substrate are set so that the ratio of a to b is 1.6 or more, i.e. a/b≧1.6 is satisfied. In summary, the distance a from a first boundary portion (x) being a boundary between the first main surface 11 and the first chamfered face 14a to a point of intersection between the first main surface 11 and an extended line of the edge face 13 and the distance b from a second boundary portion (y) being a boundary between the second main surface 12 and the second chamfered face 14b to a point of intersection between the second main surface 12 and an extended line of the edge face 13 are set to satisfy a/b≧1.6.

The magnetic disk substrate shown in FIG. 1 can be formed into a magnetic disk by providing a magnetic layer and so on on both main surfaces 11 and 12. However, when forming a magnetic disk by providing a magnetic layer and so on only on one of the first and second main surfaces 11 and 12 as described before, it is preferable to form the magnetic layer and so on on the second main surface 12 having a larger area. Since the second main surface 12 of the magnetic disk substrate shown in FIG. 1 will be formed with the magnetic layer so as to be used as a magnetic recording surface, it is preferably provided with as large a magnetic recording region as possible. In view of this, the distance b is preferably as short as possible. For example, the distance b is preferably 0.22 cm or less. On the other hand, since no magnetic layer will be formed on the first main surface 11 of the magnetic disk substrate, the distance a can be set long under the condition satisfying a/b≧1.6.

By setting the different chamfered lengths at both main surfaces of the magnetic disk substrate so as to satisfy a/b≧1.6 as described above, the amounts of air entering between the substrate and polishing pads differ from each other at both main surfaces when releasing polishing surface plates after polishing. That is, a contact area between the polishing pad and the main surface with the longer chamfered length (distance a) is smaller than that between the polishing pad and the main surface with the shorter chamfered length (distance b). Accordingly, the amount of air entering between the substrate and the polishing pad is greater at the main surface with the longer chamfered length (distance a) than that at the main surface with the shorter chamfered length (distance b). As a result, the adhesion between the substrate and the polishing pad is lower at the main surface with the longer chamfered length (distance a) than that at the main surface with the shorter chamfered length (distance b) so that the substrate is easily stripped from the polishing pad at the main surface with the longer chamfered length (distance a).

Consequently, as shown at (a) in FIG. 2, it is possible to prevent substrates 22 from adhering randomly to upper and lower polishing surface plates after polishing and thus to allow the substrates 22 to adhere exclusively to one of the polishing surface plates (in the case of (a) in FIG. 2, since the chamfered length of an upper main surface is longer as shown at (b) in FIG. 2, it is possible to allow the substrates 22 to adhere exclusively to the lower polishing surface plate side). Therefore, the possibility is small that the workability is reduced or the substrates 22 are damaged during a substrate unloading operation. Further, since polishing pads 21a and 21b are provided with no groove or the like, no level difference is formed on either of the polishing pads 21a and 21b and thus the degradation in quality of the substrates 22 after polishing does not occur. For example, the waviness (microwaviness) of the substrates 22 is not deteriorated.

Further, since the chamfered lengths are set different from each other at both main surfaces of the magnetic disk substrate, when it is used as a substrate for a magnetic disk provided with a magnetic layer only on its one side, the main surface for use as a magnetic recording surface can be easily identified. Therefore, the magnetic disk substrates can be placed or stored by orienting their main surfaces for use as magnetic recording surfaces uniformly in the same direction.

As a material of the magnetic disk substrate, use can be made of an aluminosilicate glass, a sodalime glass, a borosilicate glass, or the like. Particularly, the aluminosilicate glass can be preferably used because it can be chemically strengthened and it can provide a magnetic disk glass substrate excellent in flatness of main surfaces thereof and in substrate strength. Since the effect of this embodiment can be exhibited regardless of the type of magnetic disk substrate, this embodiment is applicable not only to a glass substrate but also to other types of magnetic disk substrates (aluminum substrate etc.).

A magnetic disk substrate manufacturing method includes processes such as Material Processing Process and First Lapping Process; End Portion Shaping Process (coring process for forming a hole and chamfering process for forming chamfered faces at end portions (outer peripheral end portion and inner peripheral end portion) (chamfered face forming process)); Second Lapping Process; Edge Face Polishing Process (outer peripheral end portion and inner peripheral end portion); Main Surface Polishing Process (first and second polishing processes); and Chemical Strengthening Process.

Hereinbelow, the respective processes of the magnetic disk substrate manufacturing method will be described. Herein, a description will be given of the case where a magnetic disk substrate is a glass substrate.

(1) Material Processing Process and First Lapping Process

First, in the material processing process, a glass blank, which will be a glass substrate, can be manufactured by a known manufacturing method such as a press method, a float method, a downdraw method, a redraw method, or a fusion method using, for example, a molten glass as a material. If the press method is used among these methods, a plate-like glass can be manufactured at low cost.

In the first lapping process, lapping is applied to both main surfaces of the plate-like glass, thereby obtaining a disk-shaped glass blank. The lapping can be carried out by using a double-side lapping machine employing a planetary gear mechanism with the use of alumina-based free abrasive particles. Specifically, the lapping is carried out by pressing lapping surface plates onto both main surfaces of the plate-like glass from the upper and lower sides, supplying a grinding fluid containing the free abrasive particles onto the main surfaces of the plate-like glass, and relatively moving them to each other. By this lapping, a glass substrate having flat main surfaces can be obtained.

(2) End Portion Shaping Process (Coring Process for Forming a Hole and Chamfering Process for Forming Chamfered Faces at End Portions (Outer Peripheral End Portion and Inner Peripheral End Portion) (Chamfered Face Forming Process))

In the coring process, using, for example, a cylindrical diamond drill, an inner hole is formed at a central portion of the glass substrate, thereby obtaining an annular glass substrate. In the chamfering process, grinding is applied to an outer peripheral edge face and an inner peripheral edge face by using diamond grindstones, thereby carrying out predetermined chamfering to form chamfered faces.

(3) Second Lapping Process

In the second lapping process, second lapping is applied to both main surfaces of the obtained glass substrate in the same manner as in the first lapping process. By performing this second lapping process, minute irregularities, surface damages, cracks, and the like formed on the main surfaces of the glass substrate in the previous processes are removed and the surface roughness thereof is further reduced than that in the first lapping process, so that it becomes possible to complete a subsequent polishing process of the main surfaces of the glass substrate in a short time.

(4) Edge Face Polishing Process

In the edge face polishing process, the outer peripheral edge face and the inner peripheral edge face of the glass substrate are mirror-polished by a brush polishing method. In this event, as polishing abrasive particles, use can be made of, for example, a slurry (free abrasive particles) containing cerium oxide abrasive particles. By this edge face polishing process, contaminants, damages, cracks, and the like on the edge faces of the glass substrate are removed so that the edge faces of the glass substrate are finished to a state that can prevent precipitation of sodium or potassium ions that would otherwise cause corrosion.

(5) Main Surface Polishing Process (First Polishing Process)

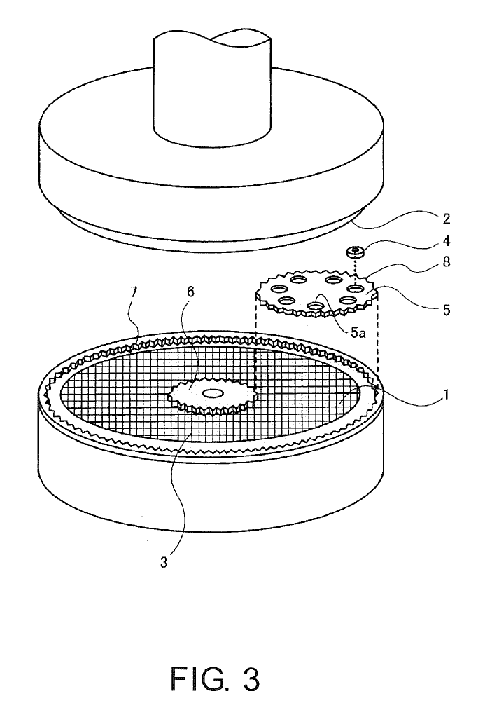

The first polishing process is first carried out as a main surface polishing process. In the main surface polishing process, polishing is carried out by using, for example, a double-side polishing machine employing a planetary gear mechanism, which is shown in FIG. 3. The first polishing process mainly aims to remove cracks, strains, and the like remaining on the main surfaces of the glass substrate during the above-mentioned lapping processes. In this first polishing process, the main surfaces of the glass substrate are polished using the double-side polishing machine having the planetary gear mechanism with the use of a hard resin polisher. Cerium oxide abrasive particles can be used as a polishing agent.

In the polishing machine of FIG. 3, a disk-shaped carrier 5 holding disk-shaped substrates 4 in the state where directions of main surfaces thereof are aligned is placed between polishing surface plates 1 and 2, then the carrier 5 is pressed between the polishing surface plates 1 and 2, and then the upper polishing surface plate 2 and the lower polishing surface plate 1 are rotated in opposite directions to each other, thereby polishing both main surfaces of the substrates 4 while supplying the polishing agent. In the planetary gear mechanism, the carrier 5 is placed between a sun gear 6 provided at a central portion of the lower polishing surface plate 1 and an internal gear 7 provided at the outer periphery of the lower polishing surface plate 1. In this event, a tooth portion 8 provided on the circumference of the carrier 5 meshes with the sun gear 6 and the internal gear 7. Therefore, by rotating the upper polishing surface plate 2 and the lower polishing surface plate 1 in opposite directions to each other, the carrier 5 revolves around the sun gear 6, i.e. makes an orbital motion, while rotating on its axis. The substrates 4 are held in holes 5a of the carrier 5, respectively.

(6) Main Surface Polishing Process (Final Polishing Process)

Then, the second polishing process is carried out as a final polishing process. The second polishing process aims to finish only one of or both of the main surfaces, which will serve as a recording surface or recording surfaces, of the glass substrate into a mirror surface or mirror surfaces. In the second polishing process, the main surface/surfaces of the glass substrate is/are mirror-polished using the double-side polishing machine having the planetary gear mechanism with the use of a soft resin foam polisher in the same manner as described above. As a slurry, use can be made of cerium oxide abrasive particles, colloidal silica, or the like finer than the cerium oxide abrasive particles used in the first polishing process.

(7) Chemical Strengthening Process

In the chemical strengthening process, chemical strengthening is applied to the glass substrate having been subjected to the above-mentioned lapping processes and polishing processes. As a chemical strengthening solution for use in the chemical strengthening, use can be made of, for example, a mixed solution of potassium nitrate (60%) and sodium nitrate (40%). The chemical strengthening is carried out by heating the chemical strengthening solution to 300° C. to 400° C., preheating the cleaned glass substrate to 200° C. to 300° C., and immersing the glass substrate in the chemical strengthening solution for 3 hours to 4 hours. In order to chemically strengthen the entire surfaces of the glass substrate, the immersion is preferably carried out in the state where a plurality of glass substrates are placed in a holder so as to be held at their edge faces.

By carrying out the immersion in the chemical strengthening solution as described above, lithium ions and sodium ions in a surface layer of the glass substrate are replaced by sodium ions and potassium ions having relatively large ionic radii in the chemical strengthening solution, respectively, so that the glass substrate is strengthened.

Next, some Examples will be described.

### Example 1

First, a molten aluminosilicate glass was formed into a disk shape by direct pressing using upper, lower, and drum molds, thereby obtaining an amorphous plate-like glass blank. In this event, the diameter of the blank was 66 mm. Then, first lapping was applied to both main surfaces of the blank, then, using a cylindrical core drill, processing (coring) was carried out to form a hole at a central portion of the blank, thereby obtaining an annular glass substrate having an outer peripheral edge face and an inner peripheral edge face. Then, chamfering (chamfered face forming process) was carried out to form chamfered faces at end portions (outer peripheral end portion and inner peripheral end portion), thereby obtaining a glass substrate with a diameter of 2.5 inches. In this event, the chamfering was carried out so that the chamfered length of the upper main surface was made longer than that of the lower main surface. Specifically, the ratio a/b between the distance a from a boundary point between the upper main surface and the chamfered face on the upper main surface side to a point of intersection between the upper main surface and an extended line of the edge face and the distance b from a boundary point between the lower main surface and the chamfered face on the lower main surface side to a point of intersection between the lower main surface and an extended line of the edge face was set to 1.6.

Then, second lapping was applied to this glass substrate. Then, the outer peripheral end portion of the glass substrate was mirror-polished by a brush polishing method. In this event, as polishing abrasive particles, use was made of a slurry (free abrasive particles) containing cerium oxide abrasive particles. Then, a first polishing process was applied as a main surface polishing process to both main surfaces of the glass substrate. In the first polishing process, the double-side polishing machine shown in FIG. 3 was used as a polishing machine. As polishing pads in this polishing machine, urethane pads were used. Cerium abrasive particles were used as a polishing agent. Polishing conditions were such that the processing surface pressure was set to 130 g/cm² and the processing rotational speed was set to 22 rpm.

After the first polishing process, a second polishing process was carried out using the same double-side polishing machine used in the first polishing process while changing the polishing pads to suede pads and the polishing agent to RO water dispersed with colloidal silica (average particle size: 0.8 μm). Polishing was carried out by placing 100 glass substrates in the polishing machine in the state where main surfaces with the longer chamfered length were facing the upper polishing surface plate side. The polishing surface plates were detached after the completion of the polishing and, as a result, the number of the glass substrates adhering to the upper polishing surface plate was zero. The microwaviness of the glass substrates after the polishing was measured by the use of Thot (trade name) manufactured by Polytech Corporation and, as a result, it was 1.3 Å and thus was excellent.

### Example 2

First and second polishing processes were applied to glass substrates in the same manner as in Example 1 except that the ratio a/b was set to 2. Polishing was carried out by placing 100 glass substrates in the polishing machine in the state where main surfaces with a longer chamfered length were facing the upper polishing surface plate side. The polishing surface plates were detached after the completion of the polishing and, as a result, the number of the glass substrates adhering to the upper polishing surface plate was zero. The microwaviness of the glass substrates after the polishing was measured in the same manner as in Example 1 and, as a result, it was 1.1 Å and thus was excellent.

### Example 3

First and second polishing processes were applied to glass substrates in the same manner as in Example 1, wherein the ratio a/b was set to 1.6 as in Example 1. Polishing was carried out by placing 100 glass substrates in the polishing machine in the state where main surfaces with a longer chamfered length were facing the lower polishing surface plate side. The polishing surface plates were detached after the completion of the polishing and, as a result, the number of the glass substrates adhering to the lower polishing surface plate was zero. The microwaviness of the glass substrates after the polishing was measured in the same manner as in Example 1 and, as a result, it was 1.2 Å and thus was excellent.

### Example 4

First and second polishing processes were applied to glass substrates in the same manner as in Example 1 except that the ratio a/b was set to 2. Polishing was carried out by placing 100 glass substrates in the polishing machine in the state where main surfaces with a longer chamfered length were facing the lower polishing surface plate side. The polishing surface plates were detached after the completion of the polishing and, as a result, the number of the glass substrates adhering to the lower polishing surface plate was zero. The microwaviness of the glass substrates after the polishing was measured in the same manner as in Example 1 and, as a result, it was 1.3 Å and thus was excellent.

### Comparative Example 1

First and second polishing processes were applied to glass substrates in the same manner as in Example 1 except that the ratio a/b was set to 1.3. Polishing was carried out by placing 100 glass substrates in the polishing machine in the state where main surfaces with a longer chamfered length were facing the upper polishing surface plate side. The polishing surface plates were detached after the completion of the polishing and, as a result, the number of the glass substrates adhering to the upper polishing surface plate was 13. The microwaviness of the glass substrates after the polishing was measured in the same manner as in Example 1 and, as a result, it was 1.2 Å and thus was excellent.

### Comparative Example 2

First and second polishing processes were applied to glass substrates in the same manner as in Example 1 except that the ratio a/b was set to 1.3. Polishing was carried out by placing 100 glass substrates in the polishing machine in the state where main surfaces with a longer chamfered length were facing the lower polishing surface plate side. The polishing surface plates were detached after the completion of the polishing and, as a result, the number of the glass substrates adhering to the lower polishing surface plate was 24. The microwaviness of the glass substrates after the polishing was measured in the same manner as in Example 1 and, as a result, it was 1.3 Å and thus was excellent.

### Comparative Example 3

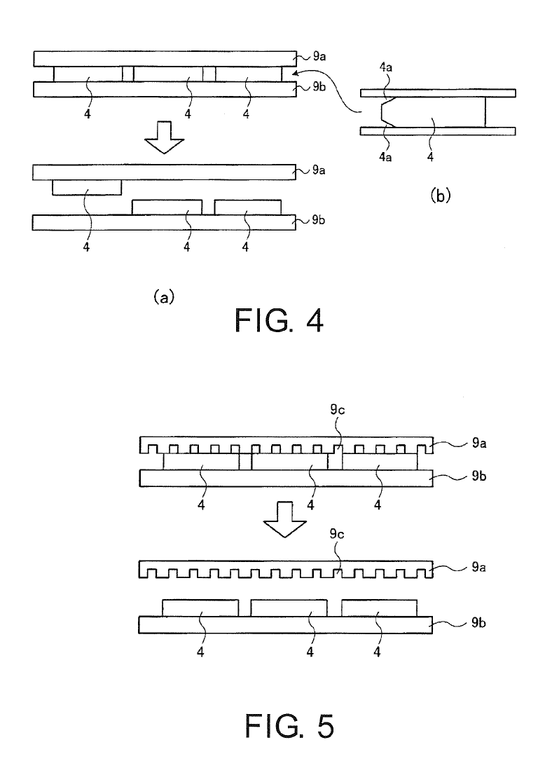

First and second polishing processes were applied to glass substrates in the same manner as in Example 1 except that the same chamfered length was set at both main surfaces (a/b was set to 1) as shown at (b) in FIG. 4. Polishing was applied to 100 glass substrates. The polishing surface plates were detached after the completion of the polishing and, as a result, the number of the glass substrates adhering to the lower polishing surface plate was 55. The microwaviness of the glass substrates after the polishing was measured in the same manner as in Example 1 and, as a result, it was 1.1 Å and thus was excellent.

### Comparative Example 4

First and second polishing processes were applied to glass substrates in the same manner as in Example 1 except that the same chamfered length was set at both main surfaces (a/b was set to 1) and grooves were formed on a polishing pad on the lower polishing surface plate side as shown in FIG. 5. Polishing was applied to 100 glass substrates. The polishing surface plates were detached after the completion of the polishing and, as a result, the number of the glass substrates adhering to the lower polishing surface plate was zero. The microwaviness of the glass substrates after the polishing was measured in the same manner as in Example 1 and, as a result, it was 2.3 Å and thus was bad.

The results of Examples 1 to 4 and Comparative Examples 1 to 4 are shown in Table 1 below.

TABLE 1

| | | Number of | Number of | |
|---|---|---|---|---|
| | | Substrates | Substrates | |
| | Chamfered | Adhering to | Adhering to | |
| | Length | Upper | Lower | Micro- |
| | Ratio | Surface Plate | Surface Plate | waviness |
| Example 1 | 1.6 | 0 | 100 | ◯ |
| Example 2 | 2 | 0 | 100 | ◯ |
| Example 3 | 1.6 | 100 | 0 | ◯ |
| Example 4 | 2 | 100 | 0 | ◯ |
| Comparative | 1.3 | 13 | 87 | ◯ |
| Example 1 | | | | |
| Comparative | 1.3 | 76 | 24 | ◯ |
| Example 2 | | | | |
| Comparative | 1 | 45 | 55 | ◯ |
| Example 3 | | | | |
| Comparative | 1 | 100 | 0 | X |
| Example 4 | | | | |

As seen from Table 1, in Examples 1 to 4, since the chamfered lengths are set different from each other at both main surfaces of the magnetic disk substrates so as to satisfy a/b≧1.6, it is possible to allow the substrates to adhere exclusively to one of the pair of polishing surface plates. Therefore, it is prevented that the workability is reduced and that the substrates are damaged during a substrate unloading operation. Further, since the polishing pads are provided with no groove or the like, it is prevented that the microwaviness is deteriorated due to a level difference on the polishing pad.

Accordingly, it is possible to prevent the substrates from adhering randomly to the upper or lower polishing surface plates after the polishing without degrading the substrate quality. Further, particularly when taking it into account to form a magnetic layer only on one of the main surfaces, it is possible to easily distinguish one from the other.

In Comparative Examples 1 to 3, since a/b≧1.6 is not satisfied at both main surfaces of the magnetic disk substrates, the substrates adhere randomly to the upper or lower polishing surface plates after the polishing. In Comparative Example 4, since the grooves are provided on the polishing pad of one of the polishing surface plates, it is possible to allow the substrates to adhere exclusively to the other polishing surface plate side. However, the microwaviness is deteriorated due to a level difference on the polishing pad.

Various exemplary embodiments of this invention will be enumerated in the following items 1-5.

1. A magnetic disk substrate comprising:

a first and a second main surface opposite to each other;

an edge face located between the first and second main surfaces;

a first chamfered face connecting between the first main surface and the edge face; and

a second chamfered face connecting between the second main surface and the edge face,

wherein a distance a from a first boundary portion being a boundary between the first main surface and the first chamfered face to a point of intersection between the first main surface and an extended line of the edge face and a distance b from a second boundary portion being a boundary between the second main surface and the second chamfered face to a point of intersection between the second main surface and an extended line of the edge face are set to satisfy a/b≧1.6.

2. The magnetic disk substrate according to one of item 1, wherein the magnetic disk substrate is a glass substrate.

3. A method of manufacturing the magnetic disk substrate according to item 1 or 2, the method comprising:

preparing a polishing machine comprising a pair of surface plates and a carrier which is placed between the surface plates and adapted to make an orbital motion while rotating on its axis;

making the carrier hold a plurality of disk-shaped substrates in parallel to each other, each of the disk-shaped substrates having a first and a second main surface which are faced to the surface plates, respectively; and

polishing the first and the second main surfaces with movement of the carrier to process each of the disk-shaped substrates into the magnetic disk substrate.

4. A method of manufacturing a magnetic disk, comprising:

preparing the magnetic disk substrate according to item 1 or 2; and

forming at least a magnetic recording layer over at least one of the first and second main surfaces of the magnetic disk substrate.

5. A magnetic disk manufactured by the magnetic disk manufacturing method according to item 4.

According to the magnetic disk substrate of the item 1, the amounts of air entering between the substrate and polishing pads differ from each other at the first and second main surfaces when unloading the substrate from between a pair of surface plates after polishing. As a result, the adhesion between the substrate and the polishing pad is lower at the first main surface with a longer chamfered length (distance a) than that at the second main surface with a shorter chamfered length (distance b) so that the substrate is easily stripped from the polishing pad at the first main surface. This makes it possible to prevent substrates from adhering randomly to the pair of surface plates after polishing.

According to this manufacturing method of the item 2, since the chamfered length of the first main surface is longer than that of the second main surface, it is possible to allow the substrates to adhere exclusively to one of the pair of surface plates. Therefore, the possibility is small that the workability is reduced or the substrates are damaged during a substrate unloading operation. Further, since it is not necessary to provide grooves or the like on the polishing pads, no level difference is formed on either of the polishing pads and thus the degradation in quality of the substrates after polishing does not occur. For example, the waviness (microwaviness) of the substrates is not deteriorated.

The recording density of a magnetic disk has been increasing year by year and even a magnetic disk having a recording capacity of 100 GB or more on its one side has been developed. Currently, the magnetic disk satisfies a required recording capacity as the sum of recording capacities on both sides thereof. However, if the recording density increases in this manner, the required recording capacity will be satisfied only on one side of a magnetic disk particularly in the case of an electronic device that does not require a so large recording capacity. If the required recording capacity is satisfied only on one side of the magnetic disk as described above, the number of components can be reduced on the HDD side such that a single magnetic head is sufficient for one magnetic disk. This is advantageous in terms of cost and further makes it possible to achieve a reduction in thickness of the HDD. Therefore, it is expected that there will be an increasing need for a magnetic disk having a magnetic layer only on one side thereof. Consequently, there is required a substrate for such a magnetic disk having the magnetic layer only on its one side, i.e. a substrate adapted to use only one of its pair of main surfaces as the main surface for use in magnetic recording.

The above-mentioned magnetic disk substrate can be formed into a magnetic disk provided with a magnetic layer on both main surfaces of the substrate in the same manner as a conventional substrate. However, in view of such circumstances, taking it into account to form the magnetic layer only on one of the main surfaces, it also becomes possible to reduce the cost by applying final polishing only to the main surface to be formed with the magnetic layer. However, if a magnetic disk substrate is produced by polishing only one of its main surfaces, it may be uncertain, when forming a magnetic layer, as to which of the main surfaces was polished. For such a problem, in the above-mentioned magnetic disk substrate, since the chamfered lengths of the first and second main surfaces differ from each other, the polished main surface can be easily distinguished from the other by carrying out mapping in advance so that only a particular one of the main surfaces (e.g. only the first main surface) is polished.

This invention is applicable to various devices incorporating a HDD, such as personal computers and portable music devices.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A magnetic disk substrate comprising:
a first and a second main surface opposite to each other;
an edge face located between the first and second main surfaces;
a first chamfered face connecting between the first main surface and the edge face; and
a second chamfered face connecting between the second main surface and the edge face,
wherein a distance a from a first boundary portion being a boundary between the first main surface and the first chamfered face to a point of intersection between the first main surface and an extended line of the edge face and a distance b from a second boundary portion being a boundary between the second main surface and the second chamfered face to a point of intersection between the second main surface and an extended line of the edge face are set to satisfy a/b≧1.6.

2. The magnetic disk substrate according to one of claim 1, wherein the magnetic disk substrate is a glass substrate.

3. A method of manufacturing the magnetic disk substrate according to claim 1, the method comprising:
preparing a polishing machine comprising a pair of surface plates and a carrier which is placed between the surface plates and adapted to make an orbital motion while rotating on its axis;
making the carrier hold a plurality of disk-shaped substrates in parallel to each other, each of the disk-shaped substrates having a first and a second main surface which are faced to the surface plates, respectively; and
polishing the first and the second main surfaces with movement of the carrier to process each of the disk-shaped substrates into the magnetic disk substrate.

4. The method according to claim 3, wherein each of the disk-shaped substrates is a glass substrate.

5. A method of manufacturing a magnetic disk, comprising:
preparing the magnetic disk substrate according to claim 1; and
forming at least a magnetic recording layer over at least one of the first and second main surfaces of the magnetic disk substrate.

6. The method according to claim 5, wherein the magnetic disk substrate is a glass substrate.

7. A magnetic disk manufactured by the method according to claim 5.

8. The magnetic disk according to claim 7, wherein the magnetic disk substrate is a glass substrate.
